(19) United States
(12) Patent Application Publication
(10) Pub. No.: US 2021/0075172 A1
(43) Pub. Date: Mar. 11, 2021

(54) CARBON BRUSH AND PRODUCTION METHOD

(71) Applicant: SCHUNK CARBON TECHNOLOGY GMBH, Bad Goisern (AT)

(72) Inventor: Sarah Reynvaan, Bad Goisern (AT)

(21) Appl. No.: 16/955,397

(22) PCT Filed: Dec. 20, 2018
(86) PCT No.: PCT/EP2018/086110

§ 371 Date: Jun. 18, 2020

(30) Foreign Application Priority Data
Dec. 27, 2017 (DE) 10 2017 131 341.9

(51) Int. Cl. H01R 39/20; H01R 43/12; H02K 13/10; F04D 13/06

(52) U.S. Cl. CPC H01R 39/20; F04D 13/06; H02K 13/10; H01R 43/12

(57) ABSTRACT

The invention relates to a carbon brush and a method for producing a carbon brush for electrically contacting a contact structure, in particular a commutator or a collector ring of an electric machine, moved with respect to the carbon brush, a brush body of the carbon brush being obtained by pressing and heat-treating a material blend, the material blend being obtained by blending a graphite powder with a resin and an additive, the resin being pyrolyzed by means of heat treatment after pressing, wherein graphene is used as the additive at a portion of 0.01 to <5% by weight of the material blend.

The invention relates to a carbon brush and a method for producing a carbon brush for electrically contacting a contact structure, in particular a commutator or a collector ring of an electric machine, moved with respect to the carbon brush, a brush body of the carbon brush being obtained by pressing and heat-treating a material blend, the material blend being obtained by blending a graphite powder with a resin and an additive, wherein the resin is pyrolyzed by means of heat treatment after pressing.

Carbon brushes and brush bodies having a carbon matrix are particularly suitable for special applications, e.g., in fuel pumps. When in operation in a fuel environment or when the brush is operated in fuel pumps, particular operating conditions must be met for carbon brushes and the commutator segments interacting with the carbon brush which cannot be compared to the operating conditions prevailing outside of a fuel environment. By meeting these conditions, it was discovered that temporary overvoltage exceeding 14 volts in this fuel environment significantly shortens the service life of the brush-commutator systems since a wear of the brush and the commutator is significantly increased due to the overvoltage. The brush bodies in question are therefore generally made of a material blend made of graphite powder and pyrolyzed resin. A disadvantage is that these brush bodies have a reduced fracture strength and tend to tear. Fastening a strand on the brush body or in a bore by tamping can also easily cause tears in the brush body. It is particularly disadvantageous if the carbon brush fractures while the fuel pump is in operation.

The object of the invention at hand is therefore to reduce the likelihood of tearing when producing a carbon brush and of breaking the carbon brush during operation.

This object is attained by a method having the features of claim 1 and a carbon brush having the features of claim 14.

With the method according to the invention for producing a carbon brush for electrically contacting a contact structure, in particular a commutator or a collector ring of an electric machine, moved with respect to the carbon brush, a brush body of the carbon brush is obtained by pressing and heat-treating a material blend, the material blend being obtained by blending a graphite powder with a resin and an additive, graphene being used as the additive, the resin being pyrolyzed by means of heat treatment after being pressed, graphene being used as an additive at a portion of 0.01 to <5% by weight of the material blend.

Surprisingly, adding only a small portion of graphene to the material blend results in a significant improvement of fracture strength and prevention of tears in the finished brush body. The addition of graphene can effectively prevent tears from forming in the brush body when being pressed or mechanically processed, for example by being drilled or ground. The stability and thermal conductivity of the brush body can thus be further increased. Aside from the thus improved conductivity of the brush body and the carbon brush, possible malfunctions of the carbon brush, for example breakage of the brush body or a loosening of a strand tamped in a bore of the brush body, can be minimized during an operation time. In this case, it suffices if the material blend and the finished brush body comprise graphene at a portion of 0.01 to <5% by weight.

Natural graphite, artificial graphite or electrographite can be used for the graphite powder. The binding agent generally acts as a binding agent and can be used as a liquid or a solid, for example in powder shape, when blended with the graphite powder. The graphene is a modification of the carbon having a two-dimensional structure in which each carbon atom is surrounded by another three atoms at a 120° angle. In particular the two-dimensional structure of the graphene enables bridging spaces between particles of the graphite powder, which are filled with resin, at least partially with graphene particles without enlarging these spaces, as would be the case with comparatively larger three-dimensional particles of different additives. The graphene particles advantageously intersperse the 0.1 to 1 μm thick resin layer around the graphite particles, without enlarging a distance between the graphite particles. The material blend can be obtained with the aid of an extruder, for example. Adding graphene to the material blend has proven to improve further physical properties of the brush body.

The resin can be hardened after or during pressing, the pyrolysis of the resin being able to take place at a temperature of ≥500° C. Consequently, hardenable resin can be used so that initially a compression mold body of the brush body can be realized which is inherently stable owing to the hardening of the resin. This compression mold body can then be heat-treated within an oven, for example, so that the resin is pyrolyzed essentially completely or changed to carbon. Accordingly, carbonizing or pyrolyzing the resin is intended in the scope of the method, thereby significantly increasing a specific resistance of the brush body.

The brush body can have a portion of graphene at 0.01 to <4% by weight, preferably 0.01 to <3% by weight, particularly preferably 0.01 to <2% by weight. Surprisingly, this portion of graphene can significantly increase the rigidity and performance of the carbon brush. At the same time, only little graphene needs to be added to the material blend, meaning that the improved rigidity and performance of the carbon brush can be attained inexpensively.

Advantageously, the material blend can be made predominantly of graphite powder. Accordingly, the material blend can have a graphite portion of >50% by weight, preferably >90% by weight. The material blend can also comprise other materials, such as solid lubricants, abrasives and/or metal powder. The properties of the carbon brush and the brush body can thus be adapted to the respective use as desired.

The resin can be liquid and the graphene can be added to the liquid resin in particle shape before being mixed with the graphite powder. Generally, the resin can also be in powder shape, however, it is particularly advantageous if the resin is liquid since the graphene can be blended well with the liquid resin. The graphene can be used in particle shape as a kind of powder, the particles being plate-shaped having a two-dimensional structure. Depending on the production method of the graphene, the plates of the two-dimensional structure can be stacked or unstacked. At any rate, the particles of the graphene do not form a sphere.

The material blend can be obtained particularly easily if the liquid resin is diluted with a solvent, preferably acetone, the solvent being able to be removed after or during pressing by means of heat treatment and the resin being able to be hardened. By being diluted with a solvent, a particularly homogeneous material blend can be obtained which can be easily processed in an extruder. The graphene can then be blended particularly well with the resin. The resin can be hardened by the solvent vaporizing by means of heat treatment and thus being removed from the material blend and the thus realized brush body. When the solvent is heat-treated or vaporized, a temperature can be chosen such that the hardening process of the resin is commenced. The solvent can also be vaporized in a blender, the graphene being able to be blended with the resin, the heat treatment being able to take place after the blend has been pressed.

Alternatively thereto, the resin can be solid and be liquified using a solvent, the graphene being able to be added in particle shape to the liquid resin before being blended with the graphite powder, the resin being able to be hardened and be processed to a powder, the powder being able to be mixed with graphite powder. The powder can be blended with the graphite powder in an extruded manner.

Advantageously, the graphene and the resin can be homogeneously dispersed. This dispersion can then simply be blended with the graphite powder, whereby the graphene is easily distributed homogeneously throughout the material blend and thus in the brush body.

It has been discovered that a particularly high electrical conductivity of the brush body can be attained when graphene is used having a mean particle size of ≤2 μm.

The resin can be a thermoset or thermoplastic resin, preferably phenolic resin.

Graphene oxide (GO), reduced graphene oxide (rGO), graphene nanoplatelets (GNO) and/or carbon nanotubes (CNT) can be used as graphene which can each be single-layered or multilayered. The used graphene can be functionalized in particular as a function of its production method. By using a specific graphene, it becomes possible to advantageously adjust the properties of the carbon brush.

A further advantageous derivation of the properties of the carbon brush becomes possible if single-walled or multiwalled carbon nanotubes (CNT), carbon black and/or other graphene modifications are added to the additive. It is essential in particular when it comes to the carbon black that a particle size is comparatively small. Depending on the size distribution of the particles of the graphite powder, carbon black particles can advantageously fill larger spaces between the particles of the graphite powder.

The brush body can be multilayered, preferably double-layered or treble-layered, at least one layer having the additive and being able to be realized having a contact surface for electrically contacting the contact structure. A layer of the brush body facing away from the contact structure can have a deviating portion of graphene, for example, or even be free of graphene. The layers can differ insofar that they have differing portions of graphite powder and/or metal powder. Thus, a brush body can be obtained which enables a particularly good electrical contact at its contact surface and simultaneously a simple fastening to a strand at its end opposite the contact surface.

The carbon brush according to the invention for electrically contacting a contact structure, in particular a commutator or a collector ring of an electrical machine, moved with respect to the carbon brush is made of a brush body which consists of a hardened material blend made of a graphite powder having a pyrolyzed resin and an additive in particle shape, the additive being graphene and the brush body comprising graphene at a portion of 0.01 to <5% by weight. With regard to the advantageous effects of the carbon brush according to the invention, the description of advantages of the method according to the invention is referred to. Further advantageous embodiments of a carbon brush are derived from the dependent claims referring back to method claim 1.

The fuel pump according to the invention, in particular a petrol pump or similar, comprises an electric motor comprising a carbon brush according to the invention. Further advantageous embodiments of a fuel pump are derived from the dependent claims referring back to method claim 1.

1. A method for producing a carbon brush for electrically contacting a contact structure, in particular a commutator or a collector ring of an electric machine, moved with respect to the carbon brush, the method comprising:
forming a brush body of the carbon brush by pressing heat-treating a material blend, the material blend being obtained by blending a graphite powder with a resin and an additive, the resin being pyrolyzed by means of heat treatment after pressing characterized in that graphene is used as the additive at a portion of 0.01 to <5% by weight of the material blend.

2. The method according to claim 1, characterized in that the resin is hardened after or during pressing, the pyrolysis of the resin taking place at a temperature ≥500° C.

3. The method according to claim 1, characterized in that the brush body comprises graphene at a portion of 0.01 to <4% by weight.

4. The method according to claim 1, characterized in that the material blend is made predominantly of graphite powder.

5. The method according to claim 1, characterized in that the resin is liquid and the graphene is added in particle form to the liquid resin before being blended with the graphite powder.

6. The method according to claim 5, characterized in that the liquid resin is diluted with a solvent, the solvent being removed before or while compressing by means of heat treatment and the resin being hardened.

7. The method according to claim 5 characterized in that the resin is hard and is made liquid, the graphene in particle form being added to the liquid resin before being blended with the graphite powder, the resin becoming hardened and ground to a powder, the powder being blended with the graphite powder.

8. The method according to claim 5, characterized in that graphene and resin are dispersed homogeneously.

9. The method according to claim 1, characterized in that graphene of a mean particle size of ≤2 μm is used.

10. The method according to claim 1, characterized in that a thermoset or thermoplastic resin, is used as the resin.

11. The method according to claim 1, characterized in that graphene oxide (GO), reduced graphene oxide (rGO), graphene nanoplatelets (GNO) and/or carbon nanotubes (CNT) are used as graphene.

12. The method according to claim 1, characterized in that single-walled or multiwalled carbon nanotubes and/or carbon black is/are added to the additive.

13. The method according to claim 1, characterized in that the brush body is multilayered, preferably double-layered or treble-layered, at least one layer having the additive and being realized having a contact surface for electrically contacting the contact structure.

14. A carbon brush for electrically contacting a contact structure of an electric machine, moved with respect to the carbon brush, the carbon brush being made of a brush body comprising a hardened material blend made of graphite powder having a hardened resin and a particle-shaped additive, characterized in that the additive is graphene and the brush body comprises graphene at a portion of 0.01 to <5% by weight.

15. A fuel pump having an electric motor comprising a carbon brush according to claim 14.
